(19) United States
(12) Patent Application Publication
(10) Pub. No.: US 2024/0162423 A1
(43) Pub. Date: May 16, 2024

(54) NEGATIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventor: Seunguk KWON, Yongin-si (KR)

(21) Appl. No.: 18/466,712

(22) Filed: Sep. 13, 2023

(30) Foreign Application Priority Data
Oct. 19, 2022 (KR) 10-2022-0135250

(51) Int. Cl. H01M 4/36; C01B 32/00; C01B 33/02; H01M 4/133; H01M 4/134; H01M 4/38; H01M 4/587; H01M 10/052

(52) U.S. Cl. CPC H01M 4/366; C01B 32/00; C01B 33/02; H01M 4/133; H01M 4/134; H01M 4/386; H01M 4/587; H01M 10/052; H01M 2004/027

(57) ABSTRACT

A negative electrode for a rechargeable lithium battery and a rechargeable lithium battery including the same, and the negative active material may include a core consisting of silicon particles having a particle diameter of about 0.8 μm to about 2 μm and an amorphous carbon coating layer formed on a surface of the core.

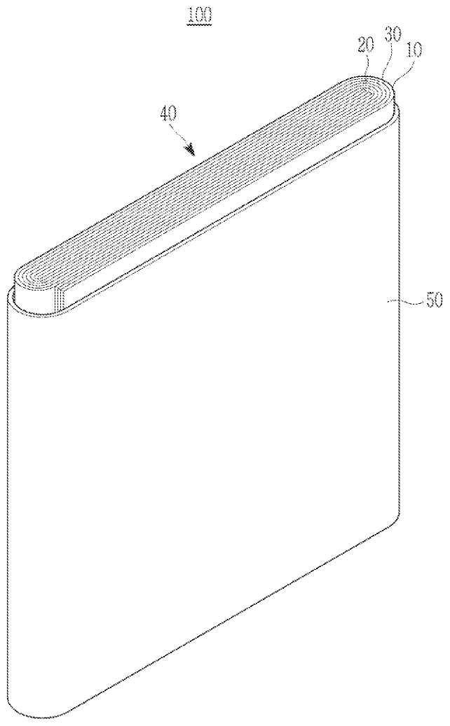

### CROSS-REFERENCE TO RELATED APPLICATION

This application claims priority to and the benefit of Korean Patent Application No. 10-2022-0135250, filed in the Korean Intellectual Property Office on Oct. 19, 2022, the entire content of which is incorporated herein by reference.

### BACKGROUND

### 1. Field

Embodiments of the present disclosure described herein are related to a negative electrode for a rechargeable lithium battery and a rechargeable lithium battery including the same.

### 2. Description of the Related Art

A rechargeable lithium battery which has recently drawn attention as a power source for small portable electronic devices, uses an organic electrolyte solution and thereby, has twice or more as high a discharge voltage as a battery utilizing an alkali aqueous solution and accordingly, high energy density.

As the negative active material for the rechargeable lithium battery, the investigation for a silicon negative active material with a high discharge specific capacity of about 3400 mAh/g, which is capable of rapidly bonding to lithium ions and enabling fast charging and discharging have been actively undertaken.

However, silicon has low high-rate charge and discharge characteristics.

### SUMMARY

An aspect according to one or more embodiments is directed toward a negative active material for a rechargeable lithium battery exhibiting high power

An aspect according to one or more embodiments is directed toward a rechargeable lithium battery including the negative active material.

Additional aspects will be set forth in part in the description which follows and, in part, will be apparent from the description, or may be learned by practice of the presented embodiments of the disclosure.

According to one embodiment, a negative active material for a rechargeable lithium battery may include a core consisting of silicon particles having a particle diameter of about 0.8 μm to about 2 μm; and an amorphous carbon coating layer on a surface of the silicon particle core.

According to one embodiment, an amount of the amorphous carbon may be about 20 wt % or less based on the total 100 wt % of the negative active material. According to one embodiment, an amount of the amorphous carbon may be about 5 wt % to about 20 wt % based on the total 100 wt % of the negative active material.

According to one embodiment, the silicon particles may have a particle diameter of about 0.8 μm to about 1.5 μm.

According to one embodiment, the amorphous carbon may be soft carbon, hard carbon, mesophase pitch carbide, sintered cokes, or combinations thereof.

According to another embodiment, a rechargeable lithium battery may include a negative electrode including a negative active material layer including the negative active material; a positive electrode including a positive active material; and a non-aqueous electrolyte.

According to one embodiment, an amount of the silicon particles may be about 80 wt % or more based on the total 100 wt % of the negative active material layer, and an amount of the silicon particles may be about 80 wt % to about 95 wt % based on the total 100 wt % of the negative active material layer.

According to one embodiment, a negative active material for a rechargeable lithium battery may provide a rechargeable lithium battery exhibiting high power characteristics.

Other embodiments are included in the following detailed description.

### BRIEF DESCRIPTION OF THE DRAWINGS

The drawing is a schematic view showing a structure of the rechargeable lithium battery according to one embodiment.

### DETAILED DESCRIPTION

Hereinafter, embodiments of the present disclosure are described in more detail. However, these embodiments are example, the present disclosure is not limited thereto and the present disclosure is defined by the scope of claims.

When a definition is not otherwise provided in the specification, an average particle diameter indicates an average particle diameter (D50) where a cumulative volume is about 50 volume % in a particle distribution. The average particle diameter (D50) may be measured by a method suitable to those skilled in the art, for example, by a particle size analyzer, or by a transmission electron microscopic image, a scanning electron microscopic, or field emission scanning electron microscopy (FE-SEM). In some embodiments, a dynamic light-scattering measurement device is utilized to perform a data analysis, and the number of particles is counted for each particle size range, and from this, the average particle diameter (D50) value may be easily obtained through a calculation.

A negative active material for a rechargeable lithium battery according to one embodiment may include a core consisting of silicon particles with a particle diameter of about 0.8 μm to about 2 μm and an amorphous carbon coating layer on a surface of the core.

In the negative active material, the core only includes, i.e., includes (e.g., consists of) only silicon particles, and particularly, includes (e.g., consists of) silicon particles having a large particle diameter, i.e. a particle diameter of about 0.8 μm to about 2 μm. The silicon particles may have a particle diameter of about 0.8 μm to about 2 μm, or about 0.8 μm to about 1.5 μm.

If the particle diameter of the silicon particles is within the range, the insertion and desertion of lithium ions mainly occur on the surface of the silicon particles during charge and discharge, and the diffusion rate of lithium may be improved during high-rate charge and discharge. The insertion of lithium up to the inside, center portion of silicon particles cause to slow down the desertion of lithium during discharging, thereby deteriorating high-rate charge and discharge characteristics. On the other side, the negative active material according to one embodiment includes silicon particles with a large particle diameter, so that the insertion and desertion of lithium mainly occur on the surface of the silicon particles, leading to a shorter distance for lithium to be desorbed during discharge, thereby improving the rate of desorbing lithium.

Moreover, the silicon particles having a particle diameter of about 0.8 μm to about 2 μm have a large reaction area which allows for more improve the diffusion speed of lithium ions.

If the particle diameter of the silicon particles is smaller than 0.8 μm, the insertion or the desertion (e.g., intercalation or deintercalation) of lithium ion occur up to the inside of the silicon particles, causing a decrease in the diffusion speed of lithium, which is not appropriate or suitable.

If the particle diameter of the silicon particles is larger than 2 μm, the reaction area is undesirably small.

The negative active material according to one embodiment includes an amorphous carbo coating layer formed on the surface of the silicon particles, which may prevent or reduce the oxidation of the silicon particle, which is the core, and thus, it may suppress or reduce to the production of silicon oxide, which may react with lithium to reduce lithium utilization. As the negative active material includes the amorphous carbon coating layer, the volume expansion of the silicon particles may be effectively suppressed or reduced during charging and discharging, and the side reaction with an electrolyte may be more prevented or reduced.

In one embodiment, an amount of the amorphous carbon coating layer may be about 20 wt % or less, about 5 wt % to about 20 wt %, about 5 wt % to about 15 wt %, or also, about 10 wt % to about 15 wt % based on the total 100 wt % of the negative active material. If the amount of the amorphous carbon coating layer is within the range, the increases in capacity, the stable electrical conductivity, and the improved cycle-life characteristics may be realized.

The negative active material according to one embodiment includes (e.g., consists of) the core (silicon particle core) and the amorphous carbon coating layer, and thus, an amount excluding the amorphous carbon may correspond to the amount of the silicon particle core.

The amorphous carbon coating layer may be soft carbon, hard carbon, mesophase pitch carbide, sintered cokes, or a combination thereof.

The negative electrode for a rechargeable lithium battery according to one embodiment includes a negative active material layer including the negative active material and a current collector supporting the negative active material layer. The negative active material is the negative active material according to one embodiment.

In the negative active material layer, an amount of silicon particles may be about 80 wt % or more, about 80 wt % to about 95 wt %, or about 80 wt % to about 84 wt % based on the total 100 wt % of the negative active material layer. As such, the negative electrode according to one embodiment may include silicon particles in the negative active material layer at a larger amount of about 80 wt % or more.

In the negative active material layer, an amount of the negative active material may be 96 wt % to 99 wt %.

The negative active material layer may include a binder, and may further include a conductive material.

An amount of the binder may be about 1 wt % to about 4 wt % based on the total 100 wt % of the negative active material layer. Furthermore, if the conductive material is further included, an amount of the negative active material may be about 96 wt % to about 98 wt % based on the total 100 wt % of the negative active material layer, an amount of the binder may be about 1 wt % to about 2 wt % based on the total 100 wt % of the negative active material layer, and an amount of the conductive material may be about 1 wt % to about 2 wt % based on the total 100 wt % of the negative active material layer.

The binder improves binding properties of negative active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylated polyvinylchloride, polyvinyl fluoride, polyurethane, polytetrafluoro ethylene, polyvinylidene fluoride, polyethylene, polypropylene, polyamideimide, polyimide, or a combination thereof.

The aqueous binder may be a styrene-butadiene rubber, an acrylated styrene-butadiene rubber (ABR), an acrylonitrile-butadiene rubber, an acryl rubber, a butyl rubber, a fluorine rubber, an ethylene oxide containing polymer, polyvinyl pyrrolidone, polyepichlorohydrin, polyphosphazene, an ethylene propylenediene copolymer, polyvinylpyridine, chlorosulfonated polyethylene, latex, a polyester resin, an acryl resin, a phenol resin, an epoxy resin, polyvinyl alcohol, or a combination thereof.

If the aqueous binder is utilized as a negative electrode binder, a cellulose-based compound may be further utilized to provide viscosity as a thickener. The cellulose-based compound includes one or more of carboxymethyl cellulose, hydroxypropylmethyl cellulose, methyl cellulose, or alkali metal salts thereof. The alkali metal may be Na, K, or Li. The thickener may be included in an amount of about 0.1 parts by weight to about 3 parts by weight based on 100 parts by weight of the negative electrode active material.

The conductive material is included to provide electrode conductivity, and any electrically conductive material may be utilized as a conductive material unless it causes a chemical change. Examples of the conductive material may be a carbon-based material such as natural graphite, artificial graphite, carbon black, acetylene black, ketjen black, carbon fiber, and/or the like; a metal-based material of a metal powder or a metal fiber including copper, nickel, aluminum, silver, and/or the like; a conductive polymer such as a polyphenylene derivative, and/or the like, or a mixture thereof.

The current collector may include one selected from a copper foil, a nickel foil, a stainless steel foil, a titanium foil, a nickel foam, a copper foam, a polymer substrate coated with a conductive metal, and a combination thereof, but is not limited thereto.

A rechargeable lithium battery according to one embodiment includes the negative electrode, a positive electrode, and an electrolyte.

The positive electrode may include a current collector and a positive active material layer formed on the current collector.

The positive electrode active material may include lithiated intercalation compounds that reversibly intercalate and deintercalate lithium ions, and specifically, one or more composite oxides of a metal selected from cobalt, manganese, nickel, and a combination thereof, and lithium may be utilized. More specifically, the compounds represented by one of the following chemical formulae may be utilized. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}Co_{b}X_{c}D¹_{α} (0.90≤a≤1.8, 0≤b≤0.5, 0≤c≤0.05, 0<α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Co_{b}X_{c}O_{2-α}T₂ (0.90≤a≤1.8, 0≤b≤0.5, 0≤c≤0.05, 0<α<2); LiₐNi_{1-b-c}Mn_{b}X_{c}D¹_{α} (0.90≤a≤1.8, 0≤b≤0.5, 0≤c≤0.05, 0<α≤α); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.5, 0≤c≤0.05, 0.001≤d≤0.1); LiₐNi_{b}Co_{b}Mn_{d}GₑO₂ (0.90≤a≤1.8, 0≤b≤0.9, 0≤c≤0.05, 0≤d0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)} J₂(PO₄)₃ (0≤f≤2); Li_{(3-f)} Fe₂(PO₄)₃ (0≤f≤2); and/or LiₐFePO₄ (0.90≤a≤1.8).

In the above chemical formulae, A is selected from Ni, Co, Mn, or a combination thereof of; X is selected from Al, Ni, Co, Mn, Cr, Fe, Mg, Sr, V, a rare earth element, or a combination thereof; D¹ is selected from O, F, S, P, or a combination thereof; E is selected from Co, Mn, or a combination thereof; T is selected from F, S, P, or a combination thereof; G is selected from Al, Cr, Mn, Fe, Mg, La, Ce, Sr, V, or a combination thereof; Q is selected from Ti, Mo, Mn, or a combination thereof; Z is selected from Cr, V, Fe, Sc, Y, or a combination thereof; J is selected from V, Cr, Mn, Co, Ni, Cu, or a combination thereof.

Also, the compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by utilizing these elements in the compound, and for example, the method may include any coating method such as spray coating, dipping, and/or the like, but is not illustrated in more detail because it is -suitable in the related field.

In the positive electrode, an amount of the positive active material may be about 90 wt % to about 98 wt % based on the total weight of the positive active material layer.

In one embodiment, the positive active material layer may further include a binder and a conductive material. Herein, the binder and the conductive material may be included in an amount of about 1 wt % to about 5 wt %, respectively based on the total amount of the positive active material layer.

The binder improves binding properties of positive active material particles with one another and with a current collector. Examples of the binder may be polyvinyl alcohol, carboxymethyl cellulose, hydroxypropyl cellulose, diacetyl cellulose, polyvinyl chloride, carboxylated polyvinylchloride, polyvinyl fluoride, an ethylene oxide-containing polymer, polyvinyl pyrrolidone, polyurethane, polytetrafluoro ethylene, polyvinylidene fluoride, polyethylene, polypropylene, a styrene-butadiene rubber, an acrylated styrene-butadiene rubber, an epoxy resin, nylon, and/or the like, but is not limited thereto.

The conductive material is included to provide electrode conductivity, and any electrically conductive material may be utilized as a conductive material unless it causes a chemical change. Examples of the conductive material include a carbon-based material such as natural graphite, artificial graphite, carbon black, acetylene black, ketjen black, carbon fiber, and/or the like; a metal-based material of a metal powder or a metal fiber including copper, nickel, aluminum, silver, and/or the like; a conductive polymer such as a polyphenylene derivative; or a mixture thereof.

The current collector may be an aluminum foil, a nickel foil, or a combination thereof, but is not limited thereto.

The positive active material layer and the negative active material layer may be prepared by mixing the active material, the binder and optionally, the conductive material in a solvent to prepare an active material composition and coating the active material composition on the current collector. Such an active material layer preparation method is suitable in the related art so that the detailed description will not be provided in the specification. The solvent may be N-methyl pyrrolidone, and/or the like, but is not limited thereto. If the aqueous binder is utilized in the negative active material layer, water may be utilized as a solvent utilized in the negative active material composition preparation.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. Furthermore, the ketone-based solvent may include cyclohexanone, and/or the like. In some embodiments, the alcohol-based solvent may include ethanol, isopropyl alcohol, and/or the like, and the aprotic solvent may include nitriles such as R—CN (where R is a C2 to C20 linear, branched, or cyclic hydrocarbon, and may include a double bond, an aromatic ring, or an ether bond), amides such as dimethylformamide, and/or the like, dioxolanes such as 1,3-dioxolane, and/or the like.

The organic solvent may be utilized alone or in a mixture. If the organic solvent is utilized in a mixture, the mixture ratio may be controlled or selected in accordance with a desirable battery performance and it may be well suitable to one in related art.

Furthermore, the carbonate-based solvent may include a mixture with a cyclic carbonate and a linear carbonate. The cyclic carbonate and linear carbonate are mixed together in a volume ratio of about 1:1 to about 1:9, and if the mixture is utilized as an electrolyte, it may have enhanced performance.

If the non-aqueous organic solvents are mixed and utilized, a mixed solvent of cyclic carbonate and linear carbonate, a mixed solvent of cyclic carbonate and a propionate-based solvent, or a mixed solvent of cyclic carbonate, linear carbonate and a propionate-based solvent may be utilized. The propionate-based solvent may include methyl propionate, ethyl propionate, propyl propionate, or a combination thereof.

Herein, if a mixture of cyclic carbonate and linear carbonate, or a mixture of cyclic carbonate and propionate-based solvent is utilized, it may be desirable to utilize it with a volume ratio of about 1:1 to about 1:9 considering the performances. Furthermore, cyclic carbonate, linear carbonate and a propionate-based solvent may be mixed and utilized at a volume ratio of 1:1:1 to 3:3:4. The mixing ratio of the solvents may be also appropriately adjusted according to the desired or suitable properties.

The non-aqueous organic solvent may further include an aromatic hydrocarbon-based solvent as well as the carbonate-based solvent. Herein, the carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

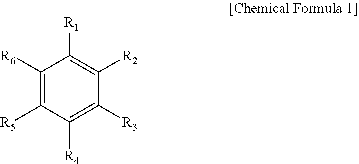

(In Chemical Formula 1, R₁ to R₆ may each independently be the same or different and are selected from hydrogen, halogen, a C1 to C10 alkyl group, a haloalkyl group, and a combination thereof.)

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinylene carbonate, or an ethylene carbonate-based compound represented by Chemical Formula 2, as an additive for improving cycle life.

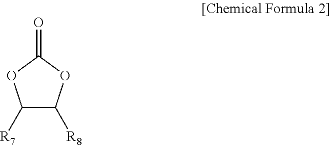

(In Chemical Formula 2, R₇ and R₈ may each independently be the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not concurrently (e.g., simultaneously) hydrogen.)

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate, and/or the like. An amount of the additive for improving the cycle-life characteristics may be utilized within an appropriate or suitable range.

The electrolyte may further include vinylethylene carbonate, propane sultone, succinonitrile, or a combination thereof, and herein, the utilized amount may be suitably adjusted.

The lithium salt dissolved in an organic solvent supplies a battery with lithium ions, basically operates the rechargeable lithium battery, and improves transportation of the lithium ions between positive and negative electrodes. Examples of the lithium salt may include one or two selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiPO₂F₂, LiN(CₓF₂ₓ₊₁SO₂)(C_{y}F_{2y+1}SO₂), where x and y are natural numbers, for example integers of 1 to 20, lithium difluoro(bisoxolato) phosphate), LiCl, LiI, LiB(C₂O₄)₂(lithium bis(oxalato) borate: LiBOB) and lithium difluoro(oxalato)borate (LiDFOB), as a supporting electrolytic salt. A concentration of the lithium salt may range from about 0.1 M to about 2.0 M. If the lithium salt is included at the above concentration range, an electrolyte may have excellent or suitable performance and lithium ion mobility due to optimal or suitable electrolyte conductivity and viscosity.

The lithium secondary battery may further include a separator between the negative electrode and the positive electrode, depending on a kind of the battery. Examples of a separator material include polyethylene, polypropylene, polyvinylidene fluoride, and multi-layers having two or more layers thereof such as a polyethylene/polypropylene double-layered separator, a polyethylene/polypropylene/polyethylene triple-layered separator, and a polypropylene/polyethylene/polypropylene triple-layered separator.

The drawing is a perspective (e.g., schematic or partially exploded) view of a rechargeable lithium battery according to an embodiment. The rechargeable lithium battery according to an embodiment is illustrated as a prismatic battery but is not limited thereto and may include variously-shaped batteries such as a cylindrical battery, a pouch battery, and/or the like.

Referring to the drawing, a rechargeable lithium battery 100 according to an embodiment may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20 and the separator 30.

Hereinafter, examples of the present disclosure and comparative examples are described. These examples, however, are not in any sense to be interpreted as limiting the scope of the present disclosure.

### Example 1

The silicon large particles having an average particle diameter D50 of 7.63 μm were pulverized via a jet-mill to prepare silicon particles having of an average particle diameter D50 of 0.93 μm.

The silicon particles were coated with a petroleum pitch, and heat-treated at 850° C. under an N₂ atmosphere to prepare a negative material including a silicon particle core and a soft carbon coating layer formed on the surface of the core. In the negative active material, the amounts of the silicon particles and the petroleum pitch utilized were adjusted so that the amount of the silicon particle core was about 90 wt % based on the total weight of the negative active material, and the amount of the soft carbon coating layer as about 10 wt % based on the total weight of the negative active material.

89 wt % of the negative active material, 3.6 wt % of a carbon black conductive material, 5 wt % of a graphite conductive material, 1.6 wt % of a styrene-butadiene rubber binder, and 0.8 wt % of a carboxymethyl cellulose thickener were mixed in a water solvent to prepare a negative active material slurry.

The negative active material slurry was coated on a Cu foil current collector and dried followed by pressurizing it utilizing the technique to prepare a negative electrode including the negative active material layer and the current collector supporting thereon. In the negative active material layer, the amount of the silicon particles was 80 wt % based on the total weight of the negative active material layer, and the amount of soft carbon was 9 wt % based on the total weight of the negative active material layer.

Using the negative electrode, a LiCoO₂ positive electrode, and an electrolyte, a 21700 rechargeable lithium full cell was fabricated. The electrolyte was utilized 1.5 M LiPF₆dissolved in a mixed solvent of ethylene carbonate, ethylmethyl carbonate, dimethyl carbonate, and fluroethylene carbonate (3:5:1.5:0.5 volume ratio).

### Example 2

The silicon large particles having an average particle diameter D50 of 7.63 μm were pulverized via a jet-mill to prepare silicon particles having an average particle diameter D50 of 1.07 μm.

Except for utilizing the silicon particles, a negative active material and a negative electrode were prepared by the same procedure as in Example 1.

Using the negative electrode, a 21700 rechargeable lithium battery was fabricated by the same procedure as in Example 1.

### Example 3

The silicon large particles having an average particle diameter D50 of 7.63 μm were pulverized via a jet-mill to prepare silicon particles having an average particle diameter D50 of 1.35 μm.

Except for utilizing the silicon particles, a negative active material and a negative electrode were prepared by the same procedure as in Example 1.

Using the negative electrode, a 21700 rechargeable lithium battery was fabricated by the same procedure as in Example 1.

### Example 4

The silicon large particles having an average particle diameter D50 of 7.63 μm were pulverized via a jet-mill to prepare silicon particles having an average particle diameter D50 of 1.95 μm.

Except for utilizing the silicon particles, a negative active material and a negative electrode were prepared by the same procedure as in Example 1.

Using the negative electrode, a 21700 rechargeable lithium battery was fabricated by the same procedure as in Example 1.

### Comparative Example 1

Except for utilizing silicon large particles with an average particle diameter D50 of 7.63 μm, a negative active material and a negative electrode were prepared by the same procedure as in Example 1.

Using the negative electrode, a 21700 rechargeable lithium battery was fabricated by the same procedure as in Example 1.

### Comparative Example 2

The silicon large particles having an average particle diameter D50 of 7.63 μm were pulverized via a jet-mill to prepare silicon particles having an average particle diameter D50 of 4.24 μm.

Except for utilizing the silicon particles, a negative active material and a negative electrode were prepared by the same procedure as in Example 1.

Using the negative electrode, a 21700 rechargeable lithium battery was fabricated by the same procedure as in Example 1.

### Comparative Example 3

The silicon large particles having an average particle diameter D50 of 7.63 μm were pulverized via a jet-mill to prepare silicon particles having an average particle diameter D50 of 0.73 μm.

Except for utilizing the silicon particles, a negative active material and a negative electrode were prepared by the same procedure as in Example 1.

Using the negative electrode, a 21700 rechargeable lithium battery was fabricated by the same procedure as in Example 1.

### Comparative Example 4

The silicon large particles having an average particle diameter D50 of 7.63 μm were pulverized via a jet-mill to prepare silicon particles having an average particle diameter D50 of 2.17 μm.

Except for utilizing the silicon particles, a negative active material and a negative electrode were prepared by the same procedure as in Example 1.

Using the negative electrode, a 21700 rechargeable lithium battery was fabricated by the same procedure as in Example 1.

### Experimental Example 1) Distribution of Particle Size

The particle size distribution of the silicon particles in the negative active materials according to Examples 1 to 4 and Comparative Examples 1 to 4 were measured utilizing a particle size analyzer (Mastersizer 3000 available from Malvern Panalytical, Ltd.). The results are shown in Table 1.

TABLE 1

| | D10 (μm) | D50 (μm) | D90 (μm) |
|---|---|---|---|
| Example 1 | 0.66 | 0.93 | 1.27 |
| Example 2 | 0.81 | 1.07 | 1.52 |
| Example 3 | 0.95 | 1.35 | 1.88 |
| Example 4 | 1.52 | 1.95 | 2.51 |
| Comparative | 2.92 | 7.63 | 14.26 |
| Example 1 | | | |
| Comparative | 1.19 | 4.24 | 11.83 |
| Example 2 | | | |
| Comparative | 0.56 | 0.73 | 1.04 |
| Example 3 | | | |
| Comparative | 1.52 | 2.17 | 3.03 |
| Example 4 | | | |

### Experimental Example 2) Evaluation of High Power

The rechargeable lithium cells according to Examples 1 to 4 and Comparative Examples 1 to 4 were charged and discharged by charging at 6 A, discharging at 6 A, and charging at 40 A and discharging at 40 A. A ratio of the discharge capacity at 40 A to the discharge capacity at 6 A was calculated. The results are shown in Table 2.

### Experimental Example 3) Evaluation of Cycle-Life Retention

The rechargeable lithium cells according to Examples 1 to 4 and Comparative Examples 1 to 4 were charged at 6 A and discharged at 40 A for 200 cycles. A ratio of the discharge capacity at 200^{th} to the discharge capacity at 1^{st} cycle was calculated. The results are shown in Table 2.

The average particle diameter (D50) of the silicon particles shown in Table 1 are also shown in Table 2. Furthermore, in Table 2, an amount of the silicon particles is based on the total weight of the negative active material layer.

TABLE 2

| | Average | | | |
|---|---|---|---|---|
| | particle | | | |
| | diameter | Amount | Discharge- | |
| | of silicon | of silicon | ability | Capacity |
| | particles | particles | at high | retention |
| | (D50, μm) | (wt %) | rate (%) | (%) |
| Example 1 | 0.93 | 80% | 90.0 | 70.9 |
| Example 2 | 1.07 | 80% | 91.0 | 71.1 |
| Example 3 | 1.35 | 80% | 89.1 | 69.6 |
| Example 4 | 1.95 | 80% | 89.7 | 73.2 |
| Com- | 7.63 | 80% | 148.1 | 35.6 |
| parative | | | | |
| Example 1 | | | | |
| Com- | 4.24 | 80% | 71.4 | 49.3 |
| parative | | | | |
| Example 2 | | | | |
| Com- | 0.73 | 80% | 77.5 | 62.2 |
| parative | | | | |
| Example 3 | | | | |
| Com- | 2.17 | 80% | 74.8 | 62.4 |
| parative | | | | |
| Example 4 | | | | |

As shown in Table 2, Examples 1 to 4 utilizing the negative active material including the silicon particles with an average particle diameter D50 of 0.8 μm to 2 μm exhibited excellent or suitable dishchargeability at high rate and capacity retention. On the other hand, when the average particle diameter D50 of the negative active material of Comparative Examples 1 to 4 was too large or too small (e.g., away from or out of 0.8 μm to 2 μm), it caused the deteriorated dischargeability at high rate and capacity retention.

The terminology utilized herein is utilized to describe embodiments only, and is not intended to limit the present disclosure. The singular expression includes the plural expression unless the context clearly dictates otherwise.

As utilized herein, “combination thereof” refers to a mixture, laminate, composite, copolymer, alloy, blend, reaction product, and/or the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout, and duplicative descriptions thereof may not be provided the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In some embodiments, “layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and/or the like.

As used herein, the term “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As used herein, the terms “use,” “using,” and “used” may be considered synonymous with the terms “utilize,” “utilizing,” and “utilized,” respectively.

The use of “may” when describing embodiments of the present disclosure refers to “one or more embodiments of the present disclosure.”

As used herein, the singular forms “a”, “an” and “the” are intended to include the plural forms as well, unless the context clearly indicates otherwise.

In the present disclosure, when particles are spherical, “size” or “diameter” indicates a particle diameter or an average particle diameter, and when the particles are non-spherical, the “size” or “diameter” indicates a major axis length or an average major axis length. That is, when particles are spherical, “diameter” indicates a particle diameter, and when the particles are non-spherical, the “diameter” indicates a major axis length. The size or diameter of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

As used herein, expressions such as “at least one of”, “one of”, and “selected from”, when preceding a list of elements, modify the entire list of elements and do not modify the individual elements of the list. For example, “at least one of a, b or c”, “at least one selected from a, b and c”, etc., may indicate only a, only b, only c, both (e.g., simultaneously) a and b, both (e.g., simultaneously) a and c, both (e.g., simultaneously) b and c, all of a, b, and c, or variations thereof.

The vehicle, a battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While this present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof. Therefore, the aforementioned embodiments should be understood to be examples but not limiting the present disclosure in any way.

What is claimed is:

1. A negative active material for a rechargeable lithium battery, the negative active material comprising
a core comprising silicon particles with a particle diameter of about 0.8 μm to about 2 μm; and
an amorphous carbon coating layer on a surface of the core.

2. The negative active material as claimed in claim 1, wherein
an amount of the amorphous carbon coating layer is about 20 wt % or less based on the total 100 wt % of the negative active material.

3. The negative active material as claimed in claim 1, wherein
an amount of the amorphous carbon coating layer is about 5 wt % to about 20 wt % based on the total 100 wt % of the negative active material.

4. The negative active material as claimed in claim 1, wherein
the particle diameter of the silicon particles is about 0.8 μm to about 1.5 μm.

5. The negative active material as claimed in claim 1, wherein
the amorphous carbon is soft carbon, hard carbon, mesophase pitch carbide, sintered cokes, or a combination thereof.

6. The negative active material as claimed in claim 1, wherein
an amount of the silicon particles is about 80 wt % or more based on the total 100 wt % of the negative active material layer.

7. The negative active material as claimed in claim 1, wherein
an amount of the silicon particle is about 80 wt % to about 95 wt % based on the total 100 wt % of the negative active material layer.

8. A rechargeable lithium battery, comprising:
a negative electrode comprising the negative active material as claimed in claim 1;
a positive electrode comprising a positive active material; and
a non-aqueous electrolyte.

9. The rechargeable lithium battery as claimed in claim 8, wherein
an amount of the silicon particles is about 80 wt % or more based on the total 100 wt % of the negative active material layer.

10. The rechargeable lithium battery as claimed in claim 8, wherein
an amount of the silicon particle is about 80 wt % to about 95 wt % based on the total 100 wt % of the negative active material layer.

11. The rechargeable lithium battery as claimed in claim 8, wherein
an amount of the amorphous carbon coating layer is about 20 wt % or less based on the total 100 wt % of the negative active material.

12. The rechargeable lithium battery as claimed in claim 8, wherein
an amount of the amorphous carbon coating layer is about 5 wt % to about 20 wt % based on the total 100 wt % of the negative active material.

13. The rechargeable lithium battery as claimed in claim 8, wherein
the particle diameter of the silicon particles is about 0.8 μm to about 1.5 μm.

14. The rechargeable lithium battery as claimed in claim 8, wherein
the amorphous carbon is soft carbon, hard carbon, mesophase pitch carbide, sintered cokes, or a combination thereof.
